(19) United States
(12) Patent Application Publication
(10) Pub. No.: US 2025/0376125 A1
(43) Pub. Date: Dec. 11, 2025

(54) OCCUPANT DETECTION AND MONITORING SYSTEM

(71) Applicants: Prasan Pandite, Black Mountain, NC (US); Jeron E. Bornstein, Delray Beach, FL (US)

(72) Inventors: Prasan Pandite, Black Mountain, NC (US); Jeron E. Bornstein, Delray Beach, FL (US)

(21) Appl. No.: 18/734,777

(22) Filed: Jun. 5, 2024

(51) Int. Cl. B60R 21/01; B60H 1/00; E05F 15/73; G08B 21/02; G08B 21/18

(52) U.S. Cl. CPC B60R 21/01; B60H 1/00742; E05F 15/73; E05F 2015/765; E05Y 2900/55; G08B 21/02; G08B 21/182

(57) ABSTRACT

The invention is a system for use in detecting and monitoring an occupant in an environment, such as within a vehicle interior. A first sensor detects the presence of the occupant within the environment, while a second sensor confirms the presence of the occupant. Once the presence of the occupant is confirmed by the sensors, the system enters an active mode and monitors the environment for a triggering event. If a triggering event is detected, the end user is notified, and immediate action is taken by the system to abate the triggering event. If the presence of the occupant is not detected by the first sensor and confirmed by the second sensor, the system remains in inactive mode and does not monitor the environment for a triggering event.

### FIELD OF THE INVENTION

The presently disclosed subject matter is directed to a supervisory system for use in association with occupant detection and monitoring in an environment, such as within a vehicle interior.

### BACKGROUND OF THE INVENTION

Every year, a considerable number of children, adults, and pets are injured and/or killed due to temperature related vehicle trauma. Specifically, infants, small children, and pets can be unintentionally left in the passenger compartment of a vehicle and suffer from heat stroke or hyperthermia. The body temperature of a child increases three to five times faster compared to an adult. Further, children are unable to dissipate heat as efficiently as adults, rendering them more susceptible to extreme temperatures. In many occurrences, the children are strapped into infant seats, are secured by seat belts, and/or are told by the driver to remain in the car. Children can also enter an unlocked vehicle during play and lock themselves within the vehicle interior or lack the ability to reopen the doors. The problem of entrapment and heat death also occurs with older, handicapped, or disoriented adults that are being transported by others. The driver may leave the vehicle unattended for a period of time longer than expected, and the temperature rise in the vehicle may be so rapid that the passenger is effectively trapped in the vehicle. Likewise, many pets or other animals left in locked vehicles die from hyperthermia. Just as with people, heat stroke in pets can cause nausea, loss of consciousness, irreparable brain damage, and death. It would therefore be beneficial to provide a system to detect and monitor the presence of a human or pet within an environment, such as the interior of a vehicle. The system can further initiate an emergency response when an alert is triggered.

### SUMMARY OF THE INVENTION

In some embodiments, the presently disclosed subject matter is directed to a detection and monitoring system. Specifically, the system comprises a first sensor configured to detect the presence or absence of an occupant within a zone of an environment. The system also includes a second sensor configured to confirm or deny the detection of the first sensor of the presence or absence of the occupant within the zone of the environment. The system further includes a communications module that initiates communication with an end user when a triggering event occurs during detection of the occupant within the zone of the environment. The term “presence” refers to when an occupant can be detected using a particular detection methodology as described herein. The term “absence” refers to when an occupant is not or cannot be detected using the presently disclosed subject matter.

In some embodiments, the first sensor is a passive infrared sensor, and the second sensor is a LIDAR sensor.

In some embodiments, the environment is the interior of a vehicle.

In some embodiments, the triggering event is a temperature within the zone greater or less than a threshold temperature range.

In some embodiments, the occupant is a child.

In some embodiments, the system further includes a pressure sensor, momentary switch, or both.

In some embodiments, the system includes a timer.

In some embodiments, the field of view of at least one sensor is about 110 degrees wide and about 22 degrees tall. Thus, the sensor field of view can be at least (or no more than) about 90, 95, 100, 105, 110, 115, 120, 125, 130, 135, or 140 degrees wide and at least (or no more than) about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 degrees tall.

In some embodiments, at least one sensor is rotatable between a first position and a second position that differ by about 90 degrees to enable columnar detection of the occupant within the zone. “Rotatable” can refer to components that rotate, such as relative to a stationary component. The rotation can be about an axis. Columnar detection can refer to a detection area in the shape of a column.

In some embodiments, the system includes a temperature and humidity sensor.

In some embodiments, the presently disclosed subject matter is directed to a method of detecting and monitoring an occupant within a zone of an environment. Specifically, the method comprises initializing (e.g., activating or waking up) the first sensor of the disclosed system to detect the presence or absence of the occupant. The method includes initializing the second sensor to detect the presence or absence of the occupant within the zone if the first sensor detects the presence of the occupant. The occupant is detected if both the first and second sensors detect the presence of the occupant within the zone. The system includes monitoring the occupant at predetermined time intervals by confirming the presence of the occupant within the zone by the initializing of the first and second sensors. The detecting and monitoring ceases when the occupant is no longer detected by at least one of the first and second sensors. If a triggering event occurs while the occupant is being monitored, corrective action is immediately taken.

In some embodiments, the predetermined time interval is about 0.1-5 minutes.

In some embodiments, voltage of the system is monitored and corrected to reduce error.

In some embodiments, temperature and humidity within the zone is further monitored.

In some embodiments, the corrective action is contacting an end user, contacting emergency services, activating a feature of the environment, or combinations thereof.

In some embodiments, activating a feature of the environment is selected from rolling down a window, turning on an air conditioning feature, rolling up a window, unlocking at least one door, sounding an alarm, or combinations thereof.

### BRIEF DESCRIPTION OF THE DRAWINGS

FIG. 1a is a fragmentary view of the inside of a vehicle comprising a detection system in accordance with some embodiments of the presently disclosed subject matter. FIG. 2a is a side plan view of an IR sensor detecting the absence of an occupant in accordance with some embodiments of the presently disclosed subject matter.

FIG. 2b is a side plan view of an IR sensor detecting the presence of an object in accordance with some embodiments of the presently disclosed subject matter.

FIG. 3 is a cross-sectional view of a pressure sensor in accordance with some embodiments of the presently disclosed subject matter.

FIGS. 4a and 4b illustrate open and closed momentary switches in accordance with some embodiments of the presently disclosed subject matter.

FIG. 5 is a side plan view of a LIDAR sensor during detection of an object in accordance with some embodiments of the presently disclosed subject matter.

FIG. 6a is a top plan view of a vehicle interior comprising a single zone in accordance with some embodiments of the presently disclosed subject matter.

FIG. 6b is a top plan view of a vehicle interior comprising a plurality of zones in accordance with some embodiments of the presently disclosed subject matter.

FIG. 7 is a schematic illustrating detection of first and second sensors to activate the detection system in accordance with some embodiments of the presently disclosed subject matter.

FIG. 8 is a schematic illustrating deactivation of the detection system in accordance with some embodiments of the presently disclosed subject matter.

FIG. 9a is a top plan view of a detected occupant in a monitored zone in accordance with some embodiments of the presently disclosed subject matter.

FIG. 9b is a top plan view of a monitored zone with no occupant detected in accordance with some embodiments of the presently disclosed subject matter.

FIG. 9c is a top plan view of a monitored zone with an inanimate object detected in a monitored zone in accordance with some embodiments of the presently disclosed subject matter.

FIG. 10a is a top plan view of a sensor monitoring a zone in accordance with some embodiments of the presently disclosed subject matter.

FIG. 10b is a cutaway view of a point of view in a zone in accordance with some embodiments of the presently disclosed subject matter.

FIGS. 10c and 10d illustrate a field of view of a sensor in the detection system in accordance with some embodiments of the presently disclosed subject matter.

FIG. 11a is a schematic illustrating vertical and horizontal rotation of a sensor in accordance with some embodiments of the presently disclosed subject matter.

FIG. 11b is a representation of vertical orientation of a sensor in accordance with some embodiments of the presently disclosed subject matter.

FIG. 11c is a representation of horizontal orientation of a sensor in accordance with some embodiments of the presently disclosed subject matter.

FIG. 12 is a system circuit in accordance with some embodiments of the presently disclosed subject matter.

FIG. 13a is a schematic of a pull up resistor in accordance with some embodiments of the presently disclosed subject matter.

FIG. 13b is a schematic of a pull down resistor in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

The presently disclosed subject matter is directed to a system that can be used to detect the presence of an occupant in an environment (e.g., vehicle interior) to prevent inadvertent injury or death due to high or low temperatures within the environment. As discussed in detail below, the disclosed system comprises a plurality of sensors that detect and confirm the presence of an occupant within the environment. The system further monitors the presence of the occupant within the environment and is configured to take appropriate action during a triggering event. A triggering event occurs when the occupant is in a confirmed detectable state within the environment and when the environment exceeds a predetermined threshold for one or more conditions (e.g., the environment is deemed critically unsafe). The term “critically unsafe” refers to any state deemed to be detrimental to the safety of the occupant. For example, the temperature within the environment (e.g., vehicle interior) can be critically unsafe when outside acceptable limits (too hot or too cold). For example, temperatures above 80° F. and below 50° F. can be considered critically unsafe in some embodiments.

The term “occupant” as used herein broadly refers to a human or animal. For example, the occupant can include humans of every age, including children (from birth to age 13 years), a child (from birth to 4 years of age), teenagers (age 13-19 years), adults (18 and older), and elderly persons (age 60 and older). The occupant can also include animals (e.g., pets).

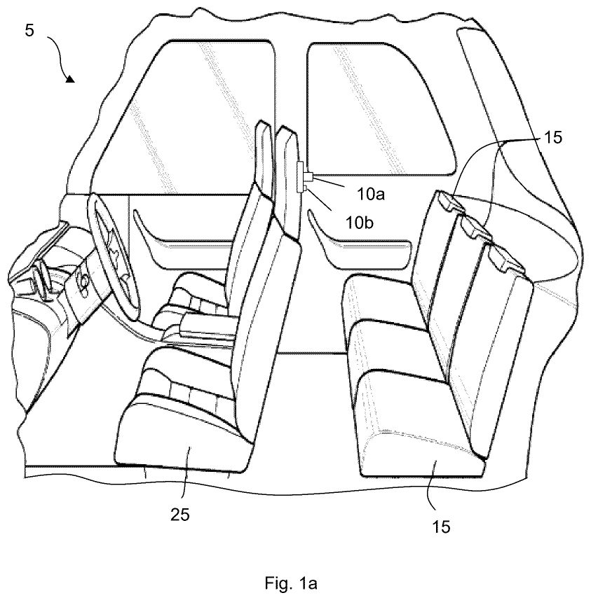

FIG. 1 illustrates one embodiment of system 5 positioned within the interior of a vehicle. As illustrated, the system includes a plurality of sensors that detect and confirm the presence of an occupant within a particular zone of an environment. The term “detect” or “detection” refers to the determination of the presence or absence of an object and/or person and/or living being. As shown, the environment can include the interior of a vehicle, including one or more rear seats 15. Specifically, first sensor 10a detects the presence of the occupant within the environment, while second sensor 10b confirms the presence of the occupant. The sensors can be positioned at any location within the environment, such as on a rear face of one or both front seats 25, the roof, the rear seats, the floor, etc. Once the presence of the occupant is detected by the first sensor and confirmed by the second sensor, the system enters “active” mode and monitors the environment for a triggering event. If a triggering event is detected, the end user is notified and immediate corrective action is taken by the system to abate the triggering event (e.g., roll down the vehicle windows, sound the horn, phone an emergency contact, turn on the vehicle air conditioning, phone the police), as explained in detail below. If the presence of the occupant is not detected both by first sensor 10a and confirmed by second sensor 10b, the system remains in inactive mode and does not monitor the environment for a triggering event. The term “monitor” or “monitoring” refers to the act of measuring, quantifying, qualifying, estimating, sensing, calculating, interpolating, extrapolating, inferring, deducing, or any combination of these actions. More generally, “monitoring” refers to a way of getting information via one or more sensing elements (such as sensors).

As noted above, system 5 includes a plurality of sensors configured as an input signal to detect the presence of an occupant within an environment. The term “sensor” broadly refers to any element that detects and/or measures a physical property and enables the recording, presentation, and/or response to the detection or measurement using processing and optionally memory. Any type of sensor can be used, such as (but not limited to) infrared sensors, LIDAR sensors, pressure sensors, momentary switches, or combinations thereof. Any sensor capable of generating an active signature in response to the physical presence of a living entity can be used.

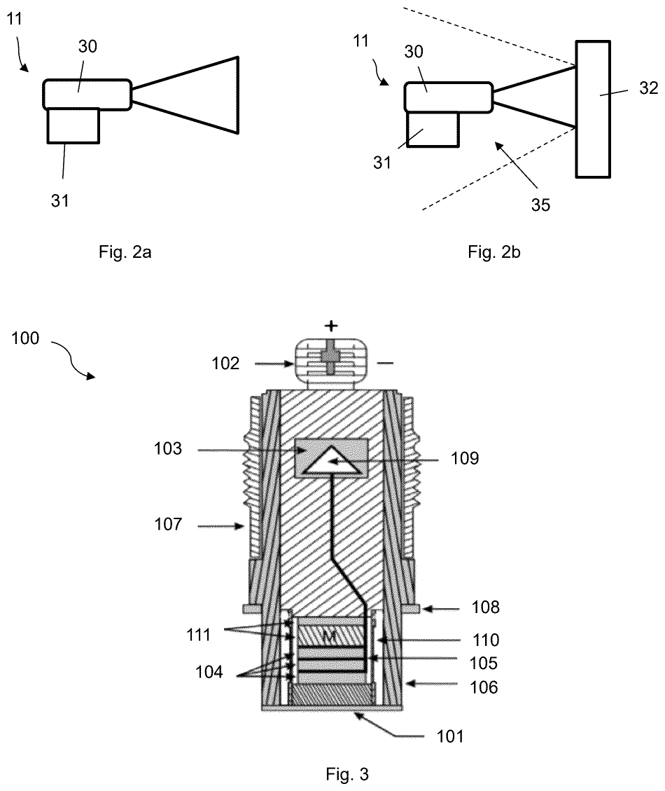

Infrared (IR) sensors detect motion in a target environment using an IR photodiode that functions as a detector, and an IR light emitting diode (LED) that functions as an emitter. When voltage is applied to the transmitter, it generates IR waves to a target. The receiver detects reflected IR waves (wavelengths from 750 nm to 1 mm) and produces a corresponding voltage. If there is not a target in the vicinity of the IR sensor, no IR waves will be reflected, and no corresponding voltage produced. The voltage levels are compared using comparators or microprocessors for further processing. For example, a microprocessor analyzes the signal received by the detector to determine temperature, position, and/or presence of an object. FIGS. 2a and 2b illustrate one embodiment of IR sensor 11 comprising transmitter 30 and detector 31. As shown in FIG. 2a, when no object 32 is present, no IR light is detected by the sensor detector. In comparison, when a target object 32 is present, reflected IR light 35 is detected by the sensor as shown in FIG. 2b.

A LIDAR (Light Detection and Ranging) sensor is configured to detect the presence of a target (e.g., child) through the use of a laser. Specifically, LIDAR sensor 12 includes light emitter 40 and light sensor 41, as shown in FIG. 5. The light emitter comprises laser 45 that directs light into an environment, such as the interior of a vehicle. When the emitted light is incident on the surface of target 42, a portion of the light is reflected and received by the light sensor, which converts light intensity to a corresponding electrical signal. Laser 45 can include ultraviolet (wavelengths of 10-400 nm), visible (400-700 nm), or near infrared (1 mm-750 nm) light to image the target. The term “laser” broadly includes any device that emits light through a process of optical amplification based on the stimulated emission of electromagnetic radiation.

As noted above, in some embodiments system 5 can include a pressure sensor. Pressure sensors are devices that measure the pressure of gases or liquids, converting the pressure into an electrical signal. The electrical signal is then processed and transmitted to control systems or monitoring equipment. Thus, when force is applied (e.g., an occupant sits in the back seat of a vehicle), it causes physical changes that result in an electrical output signal. The fundamental working principle involves a sensing element that reacts to the applied pressure, triggering the production of an output voltage.

In some embodiments, pressure sensors function by detecting changes in pressure and converting the detected changes into an electrical signal. The piezoresistive pressure sensor is one example of a pressure sensor that can be used in system 5. There are various types of pressure sensors, but one common type is the piezoresistive pressure sensor 100, as illustrated in FIG. 3. Piezoresistive pressure sensors utilize the “piezoresistive effect” wherein the electrical resistance of certain materials changes when subjected to mechanical stress or pressure. Typically, the sensors include diaphragm 101 constructed from one or more piezoresistive materials, such as silicon. When pressure is applied, the diaphragm deforms slightly. The deformation causes a change in the electrical resistance of the piezoresistive material. In some embodiments, the piezoresistive elements can be arranged in a Wheatstone bridge configuration, allowing for precise measurement of the change in resistance caused by pressure. The change in resistance is converted into an electrical signal (e.g., a voltage or current) proportional to the applied pressure. The signal can then be amplified and processed by electronic circuits.

As illustrated in FIG. 3, electrical connector 102 connecting to a mating cable for signal transmission. Potting 103 protects the wiring and internal electronics from shock. One or more quartz plates 104 generate piezoelectric output with applied pressure. Electrodes 105 collect the electrical charge. The sensor includes an exterior housing 106 to provide protection. Further, mounting clamp nut 107 secures the sensor in a mounting port. Seal ring 108 seals the sensor when mounted. As noted above, integrated circuit amplifier 109 increases the magnitude of the signal produced in response to the pressure change. The amplifier can be configured as a two-port electronic circuit that uses electric power from a power supply to increase the amplitude (magnitude of the voltage or current) of a signal applied to its input terminals, producing a proportionally greater amplitude signal at its output. Preload sleeve 110 applies a fore to the sensing element to create a rigid structure for a linear output. Acceleration compensation mass and plate 111 connect to a mating cable for signal transmission.

In some embodiments, pressure sensor 100 can detect an occupant in a vehicle via seat occupancy detection. Specifically, one or more sensors can be integrated into the seats of a vehicle. In use, when a person sits on the seat, the increased weight causes a change in pressure on the sensor. By measuring the pressure change, the system can determine whether the seat is occupied.

Alternatively or in addition, pressure sensors can form part of an occupant classification system (OCS) in vehicles. By analyzing pressure distribution in different areas of the seat, the system can classify occupants into various categories (e.g., adult, child, or no occupant).

In some embodiments, one or more sensors can be configured as a momentary switch. Momentary switches work (turn on) only for a brief period when actuated. A momentary switch automatically reverts to a default “off” position when the actuation is released. Momentary switches are typically spring-loaded to return to an original off position once pressure or force is removed. Momentary push button switches operate on a simple principle of temporarily completing or interrupting an electrical circuit. The switch includes an actuator and contacts. When the actuator (which can be a button or a lever) is pressed, it physically moves the contacts together, allowing electric current to flow through the switch and complete the circuit. The circuit stays closed as long as the actuator remains pressed, enabling the desired function or action. Once the pressure on the actuator is released, the built-in spring mechanism pushes the contacts back to their original positions to break the electrical connection and open the circuit.

Thus, a momentary switch operates by detecting physical contact and converting it into an electrical signal. While pressure sensors detect changes in pressure, momentary switches respond to changes in physical contact, typically in the form of a push or release action. In this context, the switch would be normally OPEN. The weight of the occupant would press down on the switch, closing it for an associated HIGH signal.

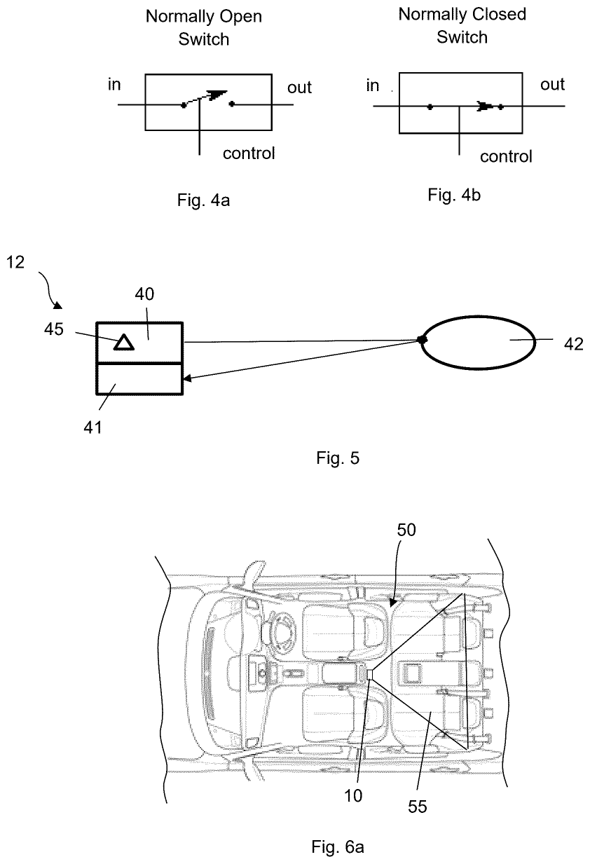

As illustrated in FIGS. 4a and 4b, momentary switches 115 utilize a simple yet effective mechanism to detect physical contact. When pressure is applied, the switch completes an electrical circuit, allowing current to flow. Conversely, when pressure is released, the circuit is broken, interrupting the flow of current. In some embodiments, momentary switch 115 include a spring-loaded button or lever mechanism. When the button is pressed, the spring is compressed, completing the circuit. Upon release, the spring returns the button to its original position, breaking the circuit once again. The action of pressing and releasing the switch generates an electrical signal. The signal can be in the form of a momentary pulse or a continuous signal, depending on the application. The signal informs connected electronic circuits of the user's input.

As noted, momentary switches can be used to determine the presence of an occupant in a vehicle. For example, momentary switches can be strategically placed in seats and/or door handles. Thus, when a person sits on the seat or opens the door, the momentary switch is engaged, signaling the presence of the person. The simple yet reliable mechanism allows system 5 to detect and respond to occupant activity. Further, momentary switches can form part of an occupant sensing and classification system in vehicles. By analyzing the activation of switches in different areas of the vehicle (e.g., seats and/or door handles), the system can classify occupants into various categories, such as driver, passenger, or rear-seat occupant.

The momentary switch and pressure sensor can be used in place and/or supplement the LIDAR/IR sensor in some embodiments. Specifically, the LIDAR/IR combination is important because the IR sensor is capable of detecting a human (due to body temperature). The presence of an IR signal means a human is present, which is a large piece of information that other sensors do not report. The LIDAR then confirms human position. In embodiments wherein the IR sensor is replaced with at least one momentary switch and/or pressure sensor, detection is limited to sensing that an object has been placed on the switch/pressure sensor and the LIDAR confirms the position of the object.

However, there are configurations that can be used to detect the presence of a human (versus merely an object). For example, an infrared thermometer (non-contact thermometer) and pressure/momentary switch can be used. An infrared thermometer is a thermometer that infers temperature from a portion of the thermal radiation emitted by the object being measured. They are sometimes called laser thermometers as a laser is used to help aim the thermometer, or non-contact thermometers or temperature guns, to describe the device's ability to measure temperature from a distance. Infrared thermometers include a lens to focus the infrared thermal radiation on to a detector, which converts the radiant power to an electrical signal that can be displayed in units of temperature after being compensated for ambient temperature. As a result, temperature measurement from a distance can be measured without contact with the object to be measured. A non-contact infrared thermometer is useful for measuring temperature under circumstances where thermocouples or other probe-type sensors cannot be used or do not produce accurate data for a variety of reasons.

By knowing the amount of infrared energy emitted by the object (e.g., a human) and its emissivity, the object's temperature can often be determined within a certain range of its actual temperature. Thus, the key is using one of the sensors to detect a human (versus an object), and the other determines if activity is located within a zone. When combined with either pressure sensors or momentary switches, infrared thermometers can provide a versatile solution for detecting human presence in various scenarios.

In some embodiments, the system can include an infrared thermometer and a pressure sensor. In use, the infrared thermometer(s) detect body heat signatures by measuring infrared radiation emitted by individuals. In combination, pressure sensors detect changes in pressure, typically when a person applies weight to a surface (e.g., a vehicle seat). By integrating infrared thermometers and pressure sensors into vehicle seats, the system can accurately detect occupants. When a person sits on the seat, body heat is detected by the infrared thermometer, while the pressure sensor confirms physical contact by registering the weight applied to the seat. The combined approach ensures reliable occupancy detection in vehicles.

In smart spaces (such as buildings and/or homes) the combination of infrared thermometers and pressure sensors can facilitate precise occupancy monitoring. Specifically, infrared thermometers detect body heat signatures, while pressure sensors installed in floors or furniture confirm the physical presence of the person. Together, a comprehensive solution for occupancy detection and management can be provided.

When an infrared thermometer is combined with a momentary switch, the momentary switch detects physical contact, typically through a push or release action. When combined with infrared thermometers, the combination offer a dual mechanism for detecting human presence.

In some embodiments, the sensor(s) can be passive or active. A “passive sensor” refers to a device that detects a phenomenon such as heat, vibration, light, radiation, etc. generated and acquires the information by inputting the corresponding information. For example, a stereo camera, a mono camera, an infrared sensor, a pan/tilt camera, etc. that operates without emitting a light source or pulse to a subject can be referred to as a passive sensor. In comparison, an “active sensor” refers to a device that includes a source, emits a light source, light, pulse, or the like to a subject, and receives information reflected from the subject. Unlike the passive sensor, the active sensor may include its own light source, actively emitting the light source to the subject, and measuring backscatter reflected from the subject to the active sensor. For example, a Time of Flight (ToF) sensor that calculates the return time after emitting a laser or infrared light to a subject, a laser sensor, a microwave sensor, or a specific pattern light is emitted to determine the distance based on the size or shape of an image formed on the subject.

Thus, system 5 can include a passive infrared sensor (PIR) in some embodiments. A PIR is an electronic sensor that measures IR light radiating from one or more targets within the field of view of the sensor. PIR sensors can detect changes in the amount of infrared radiation impinging upon it, which varies depending on the temperature and surface characteristics of the objects in front of the sensor. When an object (e.g., person) passes in front of the background, the temperature at that point in the sensor's field of view will rise from room temperature to body temperature, and then back again. The sensor converts the resulting change in the incoming infrared radiation into a change in the output voltage, triggering the detection. Objects of similar temperature but different surface characteristics may also have a different infrared emission pattern, and thus moving them with respect to the background may trigger the detector as well.

System 5 can be used in any of a wide variety of environments, such as (but not limited to) within the interior of a vehicle. The term “vehicle” refers to a device for transporting animate or inanimate objects (persons or things). Typical vehicles can include (but are not limited to) cars, trucks, buses, boats, aircraft, and the like. The interior of a vehicle can therefore include the inner portion of the vehicle (e.g., passenger area or compartment).

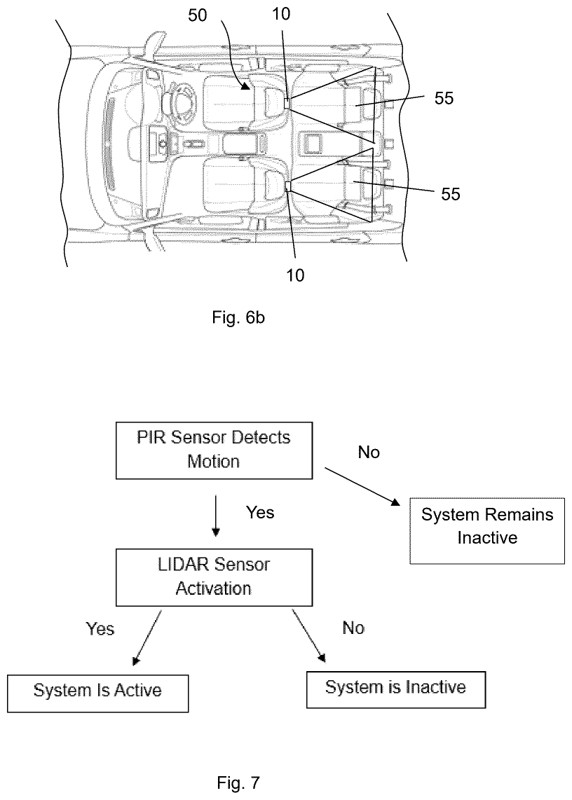

Advantageously, the sensors can be arranged in a zoned configuration to detect a triggering event quickly and efficiently within an environment. A “zoned configuration” refers to a configuration wherein all or a portion of an environment is divided into sections. For example, environment 50 (the back seat of a vehicle) can be divided into a single zone 55 as shown in FIG. 6a. Alternatively, the environment can be divided into more than one zone, as shown in FIG. 6b. The embodiment of FIG. 6b can be advantageous when multiple occupants in an environment are independently monitored. Each zone can include dedicated sensors. Each zone 55 within the environment can exhibit unique operating conditions and/or critical parameters, such as varying occupancy and evacuation route. It should be appreciated that any number of zones can be created in an environment (e.g., one zone per seat). The term “zone” thus refers to an area that is distinguished from surrounding or adjacent areas.

Through individual zone monitoring, each zone 55 of system 5 can be customized as desired by an end user. Specifically, customization ensures optimal performance and enables early detection of anomalies tailored to the characteristics of each zone. For example, if a window adjacent to a first zone within a vehicle parameter is down during cold temperatures, early detection of a drop in temperature in that zone can be detected. In response, the system can take corrective action (e.g., roll up the window) as discussed below. The “end user” refers to a user of the disclosed system and associated methods. The end user can be the driver of a vehicle in some embodiments. However, the presently disclosed subject matter is not limited and the end user can include any person with an interest in detection the presence or absence of an occupant or object within an environment.

Suitable customizations can include (but are not limited to) unoccupied reference distance (e.g., establishing a unique baseline for each sensor location, ensuring accurate detection of human presence); temperature threshold (e.g., setting temperature thresholds for automatic adjustments, maintaining a comfortable environment within each zone; evacuation route (e.g., prioritizing alerts and actions based on proximity to evacuation routes in emergency situations); control of windows, lights, and/or objects (e.g., adjustment of elements such as windows and lights based on occupancy status or environmental conditions; alert styles (e.g., offers customizable alert styles, allowing users to specify actions upon detection of activity; naming convention (e.g., assigning custom names and/or labels to each zone for easier identification and management); integration with vehicles (e.g., enhancement of monitoring and control capabilities, such as unlocking specific doors or adjusting vehicle settings; alert and notification preferences (e.g., allowing users to customize alerting and notification preferences for each zone, including preferred communication channels and escalation procedures for critical alerts); sensor sensitivity (e.g., allowing for adjustment of sensor sensitivity for each zone, ensuring optimal detection accuracy while minimizing false alarms); time-based settings (e.g., enabling scheduling of specific actions and/or alerts based on time of day, day of the week, etc., thereby allowing for automated responses during predetermined periods); occupancy profiles (e.g., allowing users to create and save occupancy profiles for different scenarios and/or usage patterns within each zone, optimizing system behavior accordingly); GPS and geofencing (e.g., incorporating geofencing capabilities to define virtual boundaries around each zone, triggering actions or alerts when occupants enter or leave these boundaries); emergency protocols (e.g., integrating predefined emergency protocols for each zone, specifying actions to be taken in response to specific emergency scenarios, such as fire or intrusions); data logging and reporting (e.g., enabling the logging of sensor data and generation of reports for each zone, providing insights into occupancy patterns, environmental conditions, and system performance over time); remote monitoring and control (e.g., facilitating remote monitoring and control of each zone via a mobile app and/or web interface, allowing users to view real-time data, adjust settings, and receive alerts from anywhere); integration with smart home systems (e.g., allowing for integration with smart home systems or platforms, allowing seamless interoperability with other connected devices and automation routines; user access controls (e.g., implementing user access controls to restrict access to certain features or zones based on user roles or permissions, ensuring security and privacy); energy management (e.g., inclusion of energy management features for each zone, optimizing energy usage based on occupancy patterns and environmental conditions to reduce energy consumption and costs); health and wellness monitoring (e.g., incorporation of health and wellness monitoring features, such as tracking air quality, humidity levels, and noise levels within each zone, promoting occupant well-being); and/or integration with third party services (e.g., offering integration with third-party services or APIs for extended functionality, such as weather forecasts, traffic updates, or smart assistant integration).

Further, a zone-based structure facilitates a modular approach to system management. Instead of examining numerous vehicles or systems, system 5 can isolate and focus on individual zones 55 while the remainder of the system continues to operate seamlessly. Accordingly, the modular design inherently directs alerts to the precise point of failure (e.g., a particular zone within the environment). An end user can therefore position sensors 10 within an environment to monitor zones 55 as needed for a particular application. Thus, zoning capabilities contribute to the scalability and flexibility of system 5. As the system expands or undergoes modifications, new zones can be easily added, removed, and/or adjusted. For example, when the environment changes (e.g., adding a third row of seating in a vehicle, moving a child car seat, operating numerous vehicles), system 5 can easily adapt. As a result, the scalability ensures that the monitoring system remains adaptable to evolving needs of the end user, irrespective of the size or configuration of the monitored zones.

In addition, the creation of one or more zones 55 within an environment enhances data management efficiency by organizing information according to zones. As a result, system 5 can analyze and interpret data more effectively, leading to informed decision-making and optimized system performance. Moreover, system 5 can be configured to store all locally. In the event of an emergency, comprehensive records of pre-event, in event, and post-event parameters can be accessible by an end user. Records of the system data serves as an asset, offering crucial insights to end-users and the like, ensuring transparency and accountability in emergency situations.

In use, two or more sensors 10 can be installed within a desired location in environment 50. For example, the sensors can be installed in a location within the interior of a vehicle. To monitor an occupant within the back seat of a vehicle, one or more pairs of sensors can be positioned adjacent from a seating area on the rear of the driver's seat (e.g., facing a car seat). Any method can be used to install sensors 10. In some embodiments, the sensors are permanently installed at a desired location in an environment. In other embodiments, the sensors can be releasably installed at a desired location, allowing a user the freedom to adjust location of sensors 10.

In system 5, the default is a combination of at least two sensors. Particularly, a first sensor is used to determine the presence of an object versus a human. The second sensor determined if the detected activity is within a defined zone within the environment (e.g., vehicle interior). As long as the two inputs are true, any combination of sensors can be used. Sensors that can determine the presence of an object versus a human include PIR, microwave sensor, and/or laser thermometer. These can be coupled with sensors to determine location and confirm the activity is in a particular zone (e.g., momentary switch, pressure sensor, and/or LIDAR).

The first sensor 10a provides initial occupancy detection within zone 55. For example, when the first sensor is a PIR sensor, movement and/or presence of the occupant is detected to provide an initial activation of the system. For example, movement of the occupant and or body heat can be detected. However, before the system is fully initiated, second sensor 10b must confirm the presence of an occupant within zone 55, as illustrated in the schematic of FIG. 7. Thus, system 5 includes a confirmation process wherein PIR sensor data can be cross-referenced with distance measurements from the LIDAR sensor to provide precise distance readings within a zone, confirming the presence of an occupant and activating the system in response.

In some embodiments, once first sensor 10a detects initial occupancy within a first zone (e.g., by motion detection and/or heat signature using a PIR sensor), a system timer is initiated. The term “timer” includes any device configured to count down in any manner (mechanical, electronic, or otherwise). The system then checks measurements from second sensor 10b for a specified time period. If an occupant is detected by the second sensor within the predetermined time period, the system is activated. If no movement is detected by the second sensor within the time period, the system remain inactive. The time period can be set by an end user as desired (e.g., at least/no more than about 0.1, 0.25, 0.5, 1, 1.5, 2, 2.5, 3, 3.5, 4, 4.5, or 5 minutes).

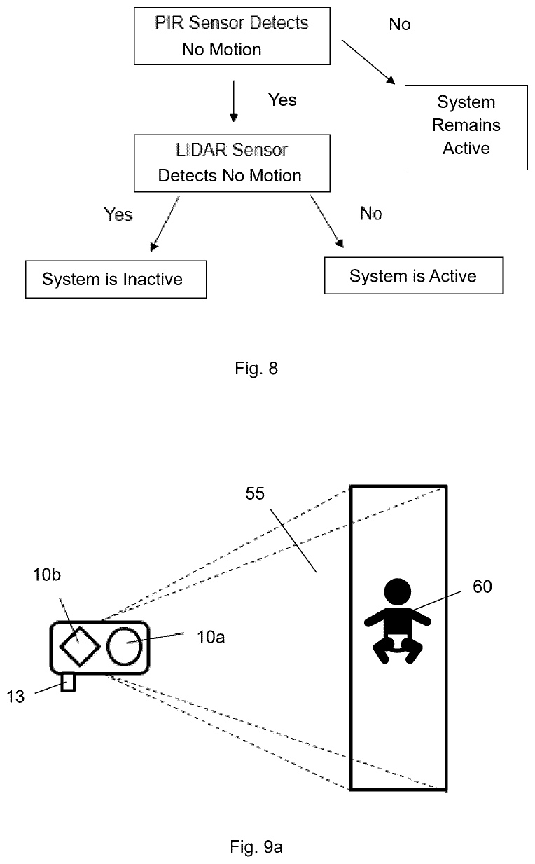

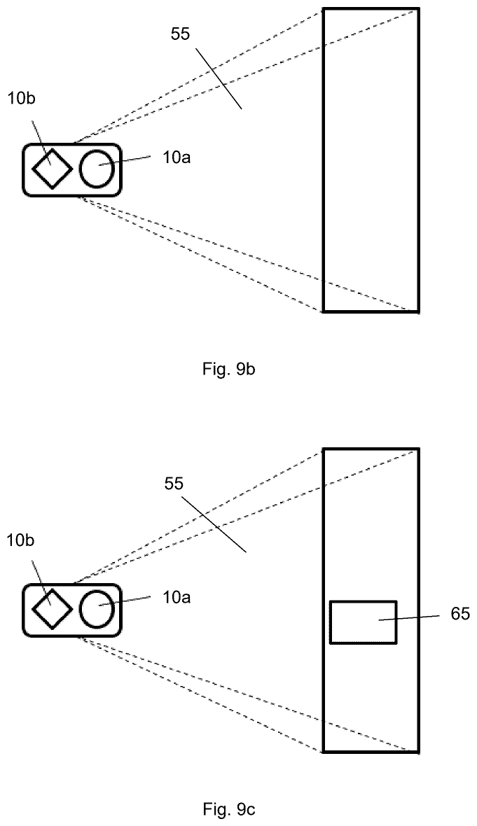

At set or predetermined time intervals, one or more system timers again detect and confirm occupancy within the occupied zone. For example, at a set time period after the system has been activated in the zone (e.g., every 0.5, 1, 2, 3, 4, or 5 minutes), first sensor 10a is activated to detect whether the zone is still occupied (e.g., a PIR sensor detects motion within the zone). If motion is detected, the system remains in active status. If no motion is detected, second timer 10b confirms a lack of occupancy (e.g., LIDAR sensor confirms no occupant is present within the zone by reading a maximum distance). Once second sensor 10b confirms the occupant has exited zone 55, the system again shifts to inactive mode, as illustrated in FIG. 8. FIG. 9a illustrates detection of occupant 60 within an environment in some embodiments. When occupant 60 enters zone 55, first sensor 10a (e.g., PIR sensor) detects motion and/or heat signature of the occupant, initiating detection of the occupant. Second sensor 10b (e.g., LIDAR sensor) confirms detection of the occupant by a decrease in the distance measure within a short window of time set by timer 13. If the second sensor confirms the presence of occupant, the system is on alert based on the indication that zone 55 is occupied (e.g., the LIDAR distance detected is less than the maximum (unoccupied) distance). The alert state is held until the occupant is no longer detected or a triggering event occurs. If the second sensor fails to confirm the presence of occupant, the system remains in inactive status based on the indication that the zone is unoccupied.

FIG. 9b illustrates system 5 upon exit of occupant 60. When the occupant exits zone 55, second sensor 10b (e.g., LIDAR sensor) detects an increase in distance back to the original threshold. If the first sensor (e.g., PIR sensor) no longer detects motion and/or a heat signature associated with the occupant, the system switches to an inactive (standby) status. Zone 55 is considered unoccupied when both the first and second sensors indicate that no occupant is present (e.g., no motion/heat signature detected by the PIR sensor and the LIDAR sensor detects a distance greater or equal to the threshold unoccupied distance after filtering). The system then enters inactive status, indicating that the zone is unoccupied.

It should be noted that filtering is a fundamental concept in signal processing, encompassing a range of techniques used to extract or modify specific components of a signal while attenuating others. Thus, filtering involves manipulating (by any mechanism) a signal to achieve desired characteristics and/or to extract relevant information while minimizing noise or interference. For example, in system 5, filtering can be used to minimize noise. Filtering can be used in both the hardware and software. LIDAR sensors and IR sensors measure very quickly (e.g., thousands of times per second). System 5 can filter the data generated by the sensors to slow down the response time and remove any unwanted noise.

In one illustrative example, a sensor as disclosed herein is mounted to the back of a driver's headrest, aimed at the rear drive-side seat (although the sensor can be mounted in a variety of locations). As the vehicle is running, system 5 indicates a reading of all clear and the zone is not occupied. A user then places a box in the rear, driver-side seat that is being monitored. While positioning the box in the back seat, one side of the box can be against the user's chest and with the user's arms are on the left and right side of the box. Consequently, the user's left arm can be in motion and in view of the PIR, as the box is placed in the seat. Additionally, as the user's left arm activates the PIR, the box would also decrease the distance measured on the LIDAR. As a result, a false alarm is generated. To remedy the situation, filters on both the circuit board and software are included.

The system can thus include hardware analog filters (on the circuit board). Low-pass filters allow frequencies below a certain cutoff frequency to pass through while attenuating higher frequencies. High-pass filters allow frequencies above a certain cutoff frequency to pass through while attenuating lower frequencies. Band-pass filters allow a specific range of frequencies to pass through while attenuating frequencies outside that range. Band-stop filters (Notch Filters) attenuate a specific range of frequencies while allowing frequencies outside that range to pass through. The noted (passive) analog filters can be used to smooth the voltage into the sensor.

On the digital software filter, a Modified Moving Average (MMA) filter may be used. The MMA is a variation of the traditional moving average filter, which is commonly used for smoothing noisy signals. The MMA filter incorporates modifications to improve its performance in certain applications, particularly in scenarios where rapid changes or sharp spikes in the signal need to be preserved. The MMA is a digital equivalent of the Low-Pass filter.

The basic moving average filter includes a window of a fixed number of consecutive samples used to calculate the average. At each time step, the filter replaces the current sample with the average of the samples within the window. The averaging process helps to smooth out rapid fluctuations in the signal, effectively reducing noise.

In a modified moving average filter, adaptive and/or variable window lengths can be introduced based on certain criteria. Instead of using a fixed window size, the MMA filter adjusts the size of the window dynamically based on the characteristics of the signal. For example, during periods of rapid changes or sharp spikes in the signal, the MMA filter may increase the window size to preserve important features of the signal. Conversely, during relatively stable periods, the filter may decrease the window size to provide faster response to changes. The modified moving average filter aims to strike a balance between smoothing the signal to reduce noise and preserving important signal features, such as sudden changes or spikes, which may be indicative of significant events or transitions in the system being monitored.

The MMA filter can be used to prevent noted false alarms. Here is the code snippet of the LIDAR MMA. A previous reading is subtracted at the current index from the total distance measured by the LIDAR sensor. Because the readings are averaged, there is a fixed total number of “averages” being updated. To update, the original value is subtracted. The LIDAR distance reading is then updated at the current index with a new reading. The newly updated reading at the current index is added to the total distance measured by the LIDAR sensor. The index used to store the latest LIDAR distance reading is then incremented. The system can be checked to determine whether the index has reached or exceeded the maximum number of readings allowed. If the index exceeds the maximum number of readings, the index is reset to zero to allow storing of readings from the beginning of the array. The average distance measured by the LIDAR sensor is measured by dividing the total distance by the number of readings. The system is checked to determine if the average distance measured by the LIDAR sensor exceeds a predefined threshold. If the average distance exceeds the threshold, the variable corresponding to an occupant is detected is set to false, indicating that no occupant is detected. The system is thus essentially looking for occupancy frame by frame. Each frame that detects an empty reading weights the reading towards 0, and each frame that reads occupied, weights toward 1. The weight takes a “while” (seconds-timescale) to move. Thus, the act of putting the box into a seat that would typically cause a false alarm, has been ignored after filtering. It should be appreciated that the passive hardware analog filters also act similarly. As the circuit goes from inactive to active, the hardware filters take a “while” (0.01-0.1 sec timescale) to filter the input. As a result, the input is filtered, delayed, and fed into the MMA digital filter.

By comparing the detected motion/heat signatures with the measured distances, system 5 ensures higher reliability in confirming that the detected motion corresponds to an occupant within the expected distance range. The multi-sensor confirmation mechanism significantly reduces false positives and enhances the system's accuracy in detecting true occupancy within the monitored zone. For example, when inanimate object 65 is positioned within zone 55, a LIDAR sensor can detect the presence of the object by comparing the distance between the unoccupied state of the zone with the distance when the object is in the zone. However, the PIR sensor fails to confirm that object 65 is a living occupant because no motion and/or heat signature is detected. As a result, the system fails to proceed to active (monitoring) mode, as illustrated in FIG. 9c.

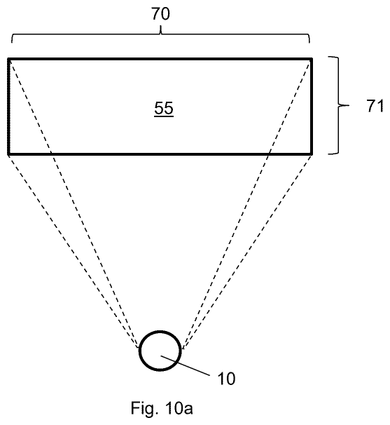

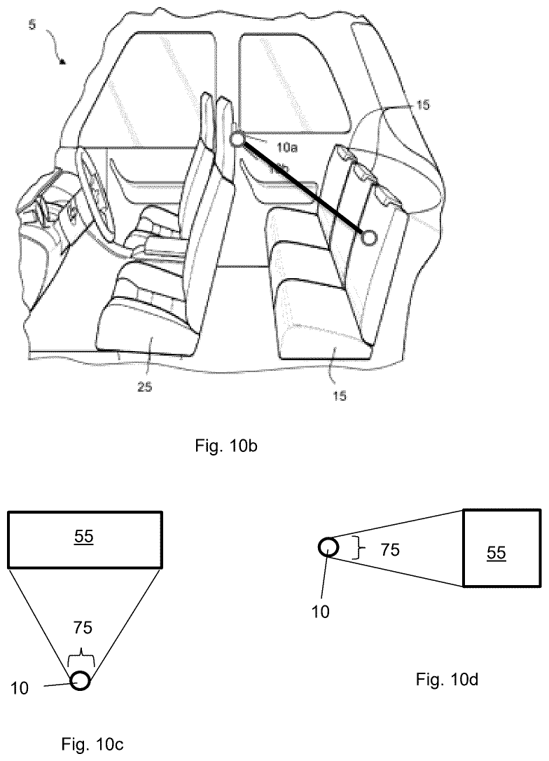

FIG. 10a illustrates one orientation of sensor 10 within zone 55. As shown, the sensor includes a predefined field of view that determines the area it can effectively monitor for motion detection. As shown, the field of view can extend horizontally in front of the sensor, covering a specific and customizable angle range. For example, zone 55 can have length 70 of about 1-10 feet (e.g., at least/no more than about 1, 2, 3, 4, 5, 6, 7, 8, 9, or 10 feet) and width 71 of about 0.5-3 feet (e.g., at least/no more than about 0.5, 1, 1.5, 2, 2.5, or 3 feet).

In some embodiments, the field of view can be defined as:

$$Height = {distance}^{*} Tan ( 22 degrees ) ;$$

$$Width = {distance}^{*} Tan ( 110 degrees ) .$$

It is noted that 22 degrees and/or 110 degrees may be appropriate for certain types of PIR, while other PIRs will have different characteristics.

The “distance” is how far away the sensor is from the target (which can be a straight line distance of about 5 feet or less). The straight line distance can be at any angle, as shown in FIG. 10b and in Table 1.

| Distance (ft) | Height (ft) | Width (ft) |
|---|---|---|
| 1.0 | 0.2 | 1.2 |
| 1.5 | 0.3 | 1.8 |
| 2.0 | 0.4 | 2.4 |
| 2.5 | 0.6 | 3.0 |
| 3.0 | 0.8 | 3.6 |
| 3.5 | 1.0 | 4.2 |
| 4.0 | 1.2 | 4.8 |
| 4.5 | 1.5 | 5.4 |
| 5.0 | 1.7 | 6.0 |
| 5.5 | 1.9 | 6.6 |
| 6.0 | 2.0 | 7.2 |
| 6.5 | 2.4 | 7.8 |
| 7.0 | 2.6 | 8.4 |
| 7.5 | 2.8 | 9.0 |
| 8.0 | 3.0 | 9.6 |
| 8.5 | 3.2 | 10.2 |
| 9.0 | 3.5 | 108 |
| 9.5 | 3.7 | 11.4 |
| 10.0 | 3.9 | 12.0 |

The table above uses the two distance*tan functions to show the height/width of the IR sensor depending on how far away it is from the target. PIR sensors can work up to 40 feet or more. It is noted that the height/weight values are reversed if the sensor is rotated 90 degrees.

In some embodiments, the field of view of the sensor 75 can be about 110 degrees wide (e.g., at least/no more than about 60, 65, 70, 75, 80, 85, 90, 95, 100, 105, 110, 115, 120, 125, 130, 135, 140, 145, 150, 155, 160, 165, 170, or 175 degrees). The term “field of view” refers to the total area that the sensor is capable of viewing three dimensions, as shown in the overhead and side views of FIGS. 10c and 10d, respectively. The term “wide” can refer to a horizontal direction (spanning left to right).

The sensor field of view can be about 22 degrees tall in some embodiments (e.g., at least/no more than about 10, 15, 20, 25, 30, 35, or 40 degrees) from a top to a bottom as illustrated in FIG. 10d. The term “tall” can refer to a vertical direction (e.g., spanning up to down).

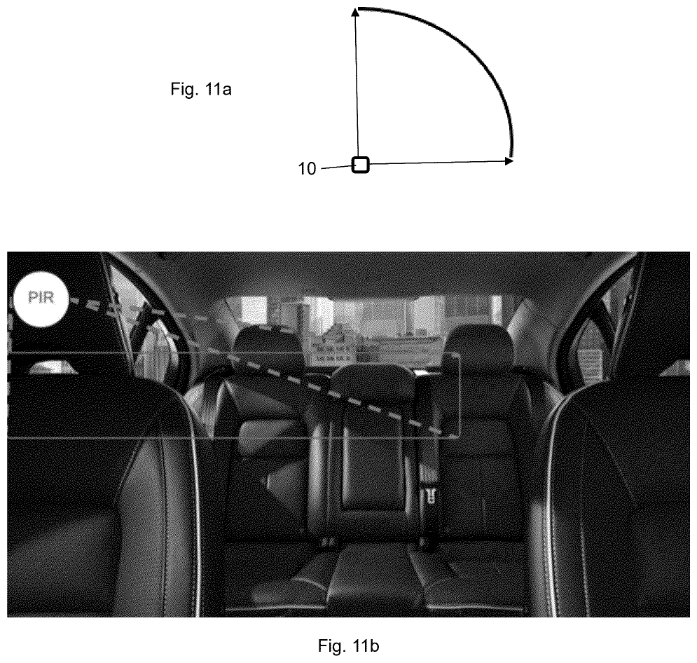

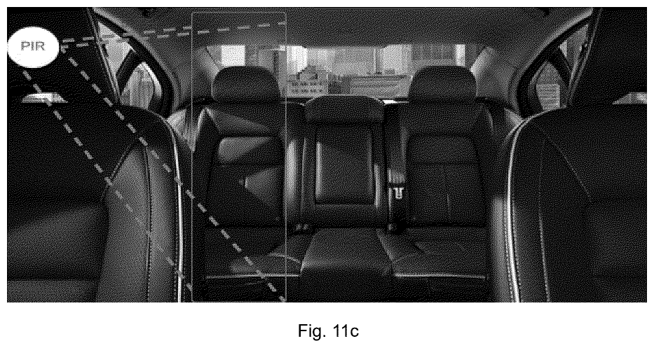

Advantageously, at least one of sensors 10 (e.g., a PIR sensor) can be rotated about 90 degrees (e.g., 30, 45, 60, or 90 degrees) as shown in FIG. 11a. In this configuration, the sensor's detection range extends primarily along its vertical axis. The unique orientation allows the sensor to monitor movement within a designated column-shaped area. The unique orientation is critical for the system to function. Specifically, by aligning the sensor to monitor a vertical column, it becomes more adept at detecting motion along a narrow vertically orientated zone. Importantly, the movement of an occupant into and out of zone 55 requires precise monitoring of vertical movement of the occupant.

A vertical column orientation ensures that the PIR sensor's detection range aligns with the area of interest, namely the seating zone in the car. The alignment maximizes the sensor's coverage over the intended space, providing more precise detection capabilities. By orienting the PIR sensor vertically, it can effectively detect motion within the confined space of the seat, which may not be adequately covered by a horizontally oriented sensor. Such an orientation ensures that even subtle movements (such as those made by a child) can be reliably detected. In a vertical orientation, the PIR sensor is optimized to detect motion along the vertical axis, matching the expected motion patterns when a person enters or exits the seat. The sensitivity is crucial for accurately capturing movements, such as a child climbing into or out of the seat. A vertical orientation minimizes the risk of false alarms triggered by motion outside the designated zone. By focusing the sensor's detection range vertically, it becomes less susceptible to irrelevant movements in the surrounding environment, such as passing vehicles or pedestrians.

By way of example, FIG. 11b illustrates a field of view that extends outside of the car and across the center seat. Additionally, the field of view does not adequately cover the seat of interest (e.g., the base of the seat is entirely out of view and unmonitored). In contrast, the view of FIG. 11c illustrates a view with the sensor rotated 90 degrees that solves the noted shortcomings and provides complete coverage of the intended zone.

Advantageously, focusing the field of view of sensor 10 vertically reduces the likelihood of false alarms triggered by movement outside the designated column zone. For example, people walking around the zone or movement within the vehicle (but outside of zone 55) are not detected. The targeted monitoring approach improves the accuracy and reliability of the sensor, efficiently reducing the likelihood of false alerts.

As noted above, sensor 10 can include a LIDAR sensor in some embodiments. The LIDAR sensor can emit laser pulses and analyze the reflected signals to accurately determine the distance between the sensor and the surfaces of objects (e.g., occupants, inanimate objects) within zone 55. The LIDAR sensor enables the confirmation of occupancy by providing reliable distance data, ensuring that the detected motion corresponds to an object within the expected proximity within a defined window of time. The zone-specific distance measurement capability enhances the ability of system 5 to confirm occupancy accurately within each monitored zone, contributing to overall system reliability and effectiveness in occupancy detection and monitoring applications.

Using a single LIDAR sensor mounted on a servo to confirm occupancy involves systematic scanning across the monitored zone and mapping the environment. As the sensor collects distance measurements from multiple angles within the zone, it creates a detailed 3D map of the surroundings, including the location and geometry of objects. By analyzing the mapped data, the LIDAR sensor coupled with appropriate logic identifies objects within the zone and compares them to predefined occupancy criteria to confirm occupancy. The process ensures that detected motion corresponds to objects that fit the correct profile. Thus, the zone-specific distance measurement capability of the single LIDAR sensor mounted on a servo enables accurate confirmation of occupancy within each monitored zone, contributing to the overall reliability and effectiveness of occupancy detection.

In one example, the LIDAR sensor starts at a predefined angle (0 degrees in some embodiments) and begins scanning the monitored zone. The sensor then takes distance measurements at regular intervals as it sweeps across the zone. During the first scan during device set-up, the LIDAR sensor collects distance measurements to create a 3D map of the surroundings. The initial scan captures the environment when it is unoccupied. The collected data forms a baseline for comparison. After the initial scan, the LIDAR sensor performs subsequent scans of the zone. As it collects distance measurements from multiple angles, it compares the new data with the baseline map created during the first scan. By analyzing the mapped data from the subsequent scans, the system identifies any changes or anomalies compared to the baseline. If the system detects objects or obstacles within the zone that were not present during the initial scan, it interprets this as occupancy.

The monitored area can be divided into discrete zones, each corresponding to a specific area of interest. In some embodiments, the system is configured to track occupancy status (occupied or unoccupied) for each zone independently. Such segmentation allows for targeted monitoring and more precise detection of occupancy within different areas. For each zone, the system compares the detected objects or obstacles against predefined occupancy criteria. The criteria may include factors such as size, shape, and/or movement patterns. If the detected objects meet the criteria, the system confirms occupancy for that particular zone. The process of scanning, mapping, and analyzing continues iteratively to provide real-time updates on occupancy status for each zone within the monitored area. By following the logic, the system can accurately confirm occupancy within each monitored zone, contributing to the overall reliability and effectiveness of occupancy detection using a single LIDAR sensor mounted on a servo.

During use of system 5, voltage levels are continuously monitored as they are critical for the proper functioning of the system. The voltage readings serve as vital inputs for sensor calibration and power management while the system is operating, impacting the performance of temperature sensors and PIR sensors. By incorporating voltage data into the calibration process, system 5 can dynamically adjust the sensitivity and threshold levels of the PIR sensor to maintain optimal performance. As a result, the likelihood of false alarms are reduced, and error-free alerts are ensured. Voltage levels provide insights into the stability of the system power supply, which directly affects the performance of the PIR sensor. Any of a variety of power sources can be used, such as a 12V DC power source derived from the car's electrical system. Through the smoothing and filtering processes, the power source can be refined to deliver a stable and clean voltage output. By reducing fluctuations and minimizing noise, the smoothed and filtered 12V DC supply ensures consistent and reliable power for sensitive electronic devices and systems within the vehicle. Fluctuations in voltage can disrupt sensor operation, leading to inaccurate readings or missed detections.

In some embodiments, the system includes a voltage divider. A voltage divider is a simple electronic circuit configuration comprising two resistors connected in series across a voltage source. The output voltage is taken from the connection between the two resistors. The ratio of the two resistors determines the output voltage relative to the input voltage. Voltage dividers are commonly used in electronic circuits for scaling down voltages, setting reference voltages, and/or providing bias voltages to components (e.g., transistors or operational amplifiers). Voltage dividers are versatile and widely employed in various applications due to their simplicity and effectiveness in voltage regulation and signal conditioning.

In some embodiments, the system can include a voltage follower to measure voltage. Specifically, the system can employ an operational amplifier configured as a voltage follower or buffer. In such a configuration, the voltage to be measured is connected to the non-inverting input of the operational amplifier, while the inverting input is connected to the output. The operational amplifier amplifies the voltage signal without altering its magnitude, providing an accurate representation of the input voltage at the output. Voltage followers are commonly used in instrumentation circuits, sensor interfacing, and voltage regulation applications.

The ECU voltage can be read directly from the vehicle OBD2 voltage PID (the car's computer). This can be implemented in addition to reading other vehicle variables.

The voltage monitoring system can further determine if the vehicle is charging (e.g., on) or not charging (e.g., off). Advantageously, monitoring system does not require complex circuitry, additional wiring to the ignition switch, reading the OBD2 port, and/or additional components. Rather, the voltage monitoring system includes a variety of digital filters, derivatives, averaging, and weighting in lieu of complex circuit, wiring, or scanning. Specifically, voltage from the circuit board is read and converted from binary to volts. The voltage status is used to output a percentage. Specifically, the function averages voltage using another MMA filter. Additionally, the voltage is scaled to a percentage value of 100. As a result, the average voltage percentage is weighted against other percentages in the last step. It should be appreciated that average voltage and average voltage percentage are not equivalents.

The actual voltage is averaged using an indexed average (a different type of MMA filter), allowing the voltage to be weighed against other voltages. The actual voltage is checked to determine whether it has changed by a set value (e.g., 0.05 Volts). The reason for this is due to the nature of how the alternator charges the car. It is noted that as the alternator enables charging, the voltage dips by 0.05 V and then rises above the original baseline voltage. Thus, the average voltage value is determined and if the value has reduced by the set value (e.g., 0.05 V) and then compared against the non-averaged (e.g., real time) voltage reading, the real time voltage reading immediately rises above the averaged baseline voltage, indicating that the charging timer should be reset.

When a vehicle is running, the charging pattern continually cycles. As a result, the timer should be continually reset. Stated another way, while the timer is under the charging threshold, the car is on. The timer should not increase beyond the charging timeout or else the car is off. The vehicle off value is then sent back to step one to be included in the filter and becomes a percentage to be used below. Specifically, the value is filtered and the running filter into average is calculated as a percentage. If the percentage off is less than 50, the vehicle is ON. If the percentage is greater than 50, the vehicle is OFF. However, if the vehicle is determined to be OFF, it is locked in the OFF status until the car is restarted. This is determined when the voltage spikes above 13V when a car is initially started and charging (e.g., not possible by a 12V battery not being charged).

In some embodiments, the system can include a temperature and/or humidity sensor to detect temperature levels and/or humidity levels within the environment. One suitable example is the digital DHT22™ sensor (available from Aosong Electric Co., Guanghou, China). However, it should be appreciated that any temperature/humidity sensor can be used. The temperature and humidity sensor can use a capacitive humidity sensor and a thermistor to measure the air within an environment to produce a digital signal. The temperature and humidity readings are essential for assessing the environmental conditions within the vehicle or monitored area and are essential for the functionality of the device itself.

For example, the temperature readings obtained from the temperature sensor are crucial for calibrating the PIR sensor against thermal background noise. Specifically, temperatures directly impact the sensitivity of the PIR sensor, affecting its ability to accurately detect motion. By combining temperature data with voltage measurements, the system can fine-tune the sensitivity settings of the PIR sensor, optimizing performance under all temperature conditions. If the voltage level was not accurately measured and suddenly changed, an incorrect temperature reading would be produced, directly affecting the PIR sensor and leading to false alarms.

Similarly, humidity levels within an environment can influence the atmospheric conditions within the monitored zone and adversely affect performance of sensors 10. For example, high humidity levels can result in fogging or condensation, impacting the accuracy of distance measurements from the LIDAR sensor. By monitoring humidity levels, the system can adjust sensor parameters to compensate for the environmental factors, ensuring accurate and reliable data capture. Separately, monitoring humidity helps in assessing and maintaining a comfortable and healthy indoor environment, particularly in enclosed spaces (e.g., vehicle interiors).

The voltage stability directly influences the overall power management of the system, which is critical for the accurate operation of all sensors, including the LIDAR sensor. Fluctuations in voltage can affect the sampling rates, thresholds, and sensitivity of the LIDAR sensor, leading to inconsistencies in distance measurements. By ensuring a stable power supply based on voltage monitoring, the system maintains the reliability and accuracy of the LIDAR sensor, essential for the system's overall functionality. The system can quickly offset sensitivity/power/duration of the LIDAR sensor due to random voltage changes, which is critical for system stability in error rejection.

In summary, voltage monitoring is essential for power management and sensor calibration within system 5. By incorporating voltage data into the calibration process, the system optimizes the performance of the temperature and PIR sensors, ensuring accurate and reliable detection capabilities. Additionally, maintaining a stable power supply based on voltage monitoring is crucial for the proper functioning of all sensors, including the LIDAR sensor, and contributes to the overall effectiveness of the system. Therefore, the constant live voltage reading is a core component used to constantly adjust sensor bias. Voltage can be measured by two resistors in series with a diode, as noted above.

By analyzing voltage levels, system 5 can determine whether the vehicle is turned off or is currently charging. A voltage below a specified threshold indicates that the vehicle is off, while a voltage above the threshold suggests that the vehicle is either running or charging. The term “threshold” refers to a level that must be reached or passed to have an effect. For example, a “temperature threshold” refers to the ceiling or minimum temperature value determined to be in a normal state (e.g., to prevent a deleterious or harmful effect on the occupant). Thus, the threshold temperature can be used to represent whether the temperature in an environment reaches the risk of the occupant overheating in some examples.

Utilizing real-time data from temperature, voltage, and humidity sensors, system 5 implements dynamic calibration algorithms designed to optimize the performance of both the PIR and LIDAR sensors. The algorithms operate continuously, dynamically adjusting sensor settings based on the prevailing environmental conditions to ensure consistent and accurate detection and measurement capabilities while the system is operational. In one illustrative example, the algorithm can function to define temperature and humidity thresholds, voltage thresholds, and sensitive levels for the PIR sensor, such as high and low sensitive values. The range setting for the LIDAR sensor is also defined (e.g. both short and long range settings). Scaling offsets for sensor adjustments based on voltage levels. Scaling offset can then be calculated based on the voltage level. PIR sensitivity can be adjusted based on temperature and humidity. For example, PIR sensor sensitivity can be increased for better detection in high temperature and humidity conditions or decreased for reduced false alarms in normal environmental conditions.

The LIDAR sensor range can be adjusted based on temperature and humidity. Foe example, if the temperature is greater than the threshold temperature and/or relative humidity is greater than the humidity threshold, LIDAR range is decreased for improved accuracy in high temperature and humidity levels. Similarly, LIDAR range can be increased in normal environmental conditions for better coverage. LIDAR range can further be adjusted in some embodiments based on PIR sensor sensitivity (e.g., LIDAR range decreased for enhanced coordination with high sensitivity PIR sensors).

The dynamic calibration function adjusts the sensitivity of the PIR sensor and the range of the LIDAR sensor in real-time to optimize detection accuracy and minimize false alarms, with additional scaling offsets applied based on voltage fluctuations. The adjustments ensure optimal sensor performance across varying environmental scenarios, enhancing the reliability and effectiveness of the sensor system. Essentially, each sensor checks its surrounding conditions, and can adjust itself accordingly.

The significance of incorporating temperature (e.g., ° F.), voltage (V), and humidity readings (percentage) into the calibration process cannot be overstated. Such a comprehensive approach maximizes sensor accuracy and reliability, even in dynamically changing environmental conditions. Notably, by continuously adapting sensor settings based on real-time data, system 5 enhances effectiveness and efficiency in detecting occupancy.

The adaptive strategy reduces the likelihood of false alarms and also promotes efficient and effective system operation. Unlike other systems that only trigger alerts when temperature or humidity thresholds are exceeded, system 5 actively utilizes temperature, voltage, and humidity readings to compensate for known failure points. Stated another way, system 5 is configured to read temperature and humidity sensors and adjust the environment as necessary (e.g., turn on the air conditioning, roll down a window) in response to ensure that the system remains functioning efficiently and dodging potential issues with sensor readings. Additionally, voltage readings are crucial for calibrating the temperature sensor, which, in turn, constantly adjusts a fundamental and critical sensor, the PIR. Therefore, accurate and live voltage and temperature readings are critical for ensuring the reliability and functionality of the system.

Thus, the ability of system 5 to dynamically calibrate sensor parameters based on real-time environmental data provides an advantage to end user. For example, users can be provided with actionable insights to ensure optimal performance across various operating conditions. Sensors 10 are configured to send alerts to end user, and also constantly compensate and calibrate to ensure maximum efficiency.

The logical flow of system 5 begins with initial occupancy detection using the first sensor 10a (which can be a PIR sensor) within each monitored zone. Upon detecting motion, the system initiates a confirmation process by cross-referencing the detection data from the first sensor with data from the second sensor (e.g., distance measurements obtained from the LIDAR sensor). The multi-sensor confirmation mechanism ensures higher reliability in distinguishing genuine occupancy from false alarms. Additionally, the system monitors voltage levels to determine the status of the vehicle and efficiently manage power consumption, while providing all necessary adjustments to the sensors. Simultaneously, temperature and humidity readings from the associated sensor provide valuable insights into environmental conditions, further enhancing effectiveness and allowing for necessary sensor adjustments to ensure optimal capabilities.

In some embodiments, the disclosed system can include a black box that can be used for operation and data recording applications. The black box can continuously collect and record various parameters related to the operation and condition within the environment. For example, the black box can collect data such as (but not limited to) vehicle speed, engine RPM, acceleration, deceleration, brake usage, steering angle, GPS location, time, date, vehicle diagnostics (e.g., engine temperature, fuel level), and occupancy zone-by-zone specific information. In some embodiments, data collection can be performed with a sampling frequency sufficient to capture relevant events and ensure accurate reconstruction of vehicle events.

The recorded data can be stored securely within the black box. Advantageously, the storage medium can be durable and resistant to environmental factors, such as temperature, humidity, and vibration. Furthermore, the data can be stored in a format that preserves integrity and allows for efficient retrieval and analysis.

Any of a wide variety of format/storage mediums can be used. For example, the system can include solid state drives (SSDs) that offer fast read and write speeds, durability, and resistance to environmental factors. SSDs are commonly used in automotive applications due to their reliability and robustness. In some embodiments, industrial-grade SD cards designed to withstand harsh environmental conditions can be used. Advantageously, they offer high storage capacities and fast data transfer rates. The system can employ embedded multimedia cards (eMMC). Specifically, eMMC storage is a type of flash storage commonly used in automotive electronics, providing reliable storage with built-in wear leveling and error correction features. The system can include hard disk drives (HDDs), offering high storage capacities at a lower cost. Further, the system can employ phone/vehicle storage that allows data to be saved directly on the user's phone and/or vehicle. In addition to onboard storage, data can also be securely transmitted and stored in the cloud, providing redundancy and accessibility while also allowing for remote retrieval and analysis of recorded data.

Upon detecting a significant event (e.g., the temperature within a zone exceeds a threshold level), the system can timestamp the event and store relevant data leading up to and following the event.

In some embodiments, access to recorded data can be restricted to authorized personnel, such as law enforcement, insurance companies, and device owners. To this end, data encryption and secure authentication mechanisms can be implemented to prevent unauthorized access or tampering with recorded data. Personal identifiable information (PII) can be handled in accordance with applicable privacy laws and regulations.

Authorized personnel can retrieve recorded data from the black box system for accident investigation, vehicle diagnostics, and other lawful purposes. The data retrieval can be conducted in a manner that preserves the integrity of the original data and ensures its admissibility in legal proceedings. Procedures for data retrieval can be documented and followed to maintain chain of custody and accountability.

Testing procedures can be established to verify the functionality of the black box system under various operating conditions and environmental factors.

The black box system can be designed to comply with relevant industry standards and regulations governing vehicle data recorders.

In some embodiments, end users (e.g., vehicle owners) are informed of the presence and function of the black box system as part of device documentation and disclosures. Consent for data collection and storage can be obtained from end users in accordance with applicable laws and regulations. Optionally, the end user has the right to opt-out of data collection or request the deletion of recorded data, subject to legal limitations.

Feedback from accident investigations, data analysis, and user experience can be used to identify areas for enhancement and refinement.

In some embodiments, documentation can be retained for the duration required by applicable regulations and industry best practices.

Data collected by the black box system may be used to automatically notify emergency services and provide critical information for rescue operations.

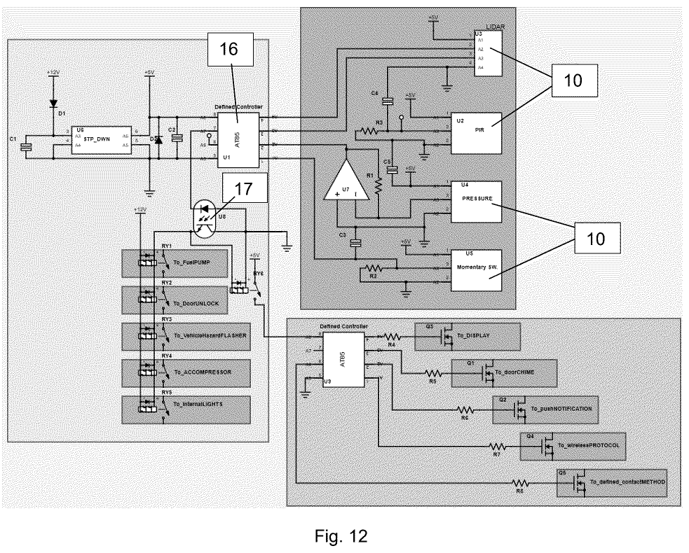

FIG. 12 illustrates one example of a circuit that can be used to generate an active signal when occupant 60 is detected within the environment. As shown, the circuit includes a plurality of input sensors 10. Any of a variety of sensors can be used, as noted above (e.g., LIDAR sensors, PIR sensors, pressure sensors, and/or momentary switch sensors). The sensor configuration and layout is not limited to the depicted diagram. Additional sensors can be used to assist in error detection, false alert rejection, and signal confirmation.

In combination with the PIR/LIDAR, any of the previously described sensors can be added to assist in error detection. For example, in addition to the PIR/LIDAR, a pressure sensor can be added under the seat to determine the approximate weight (and therefore age class, infant, child, adult). Another example would be the addition of a microwave radar sensor on both sides of the PIR, allowing for the creation of borders and narrowing the view of the PIR. Furthermore, additional sensors, such as a strain gauge, can be placed elsewhere (e.g., the driver seat) and be used to determine if the driver is still seated. In these situations, the emergency alert should not be sent because the driver is still present within the vehicle. Thus, additional sensors can be added to assist in error detection, false alert, and/or signal confirmation. Each sensor added reduces the system error greatly.

Additional filtering, signal conditioning or appropriate controls may be used to ensure the proposed device behaves in a predefined manner. The controls are dependent on which particular element is added. For example, if a strain gauge is added to the driver seat, the controls should include the appropriate thresholds, actions to take on trigger, how to clear the trigger, etc. In situations wherein microwave sensors are added to pinch the field of view of the PIR, the controls can include the desired frequency to poll the microwave, the delay, the desired width of the sensor, the desired “narrowing” effect of the PIR, actions on trigger, etc. Each element added must go through the same process of defining controls depending on the element and desired behavior.

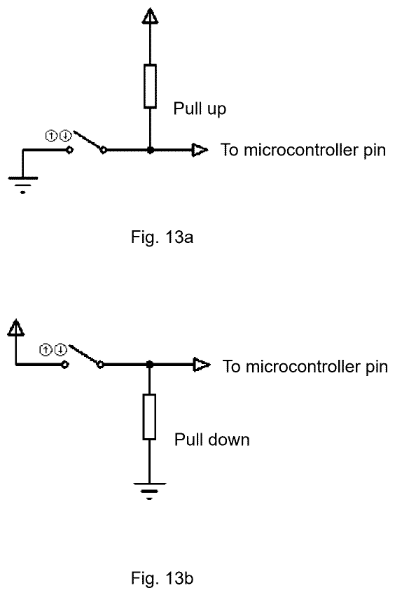

The sensor data is used by defined controller 16. The controller is designed such that the input sensor data must exceed a defined threshold to enable a HIGH signal. FIGS. 13a and 13b illustrate two common configurations for high/low signals. For reference, Ground, Low, Off, and inactive, all mean the voltage is zero (e.g., literally measuring 0 volts on the microcontroller pin (in binary, this is a 0)). Positive, High, On, and active all correspond to a voltage of greater than 1 (measuring more than 1 volt on the microcontroller pin (in binary, this is a 1) (a high signal)).

The reason for pull-down (FIG. 13b) is important for many reasons. For example, with a pull-down resistor, the default state of the input pin is low (logic 0). This ensures that the input is not left floating, which could lead to unpredictable behavior or susceptibility to noise. Pulling the signal low when inactive provides a clear reference point. Further, pull-down resistors can provide better noise immunity in noisy environments. Since they pull the signal to a low logic level, any noise picked up by the signal line is less likely to cause false triggering, as it would need to overcome the stronger pull-down resistor to drive the signal high. In the case of an open circuit or when the switch/sensor is not actively driving the signal, a pull-down resistor ensures that the input is held at a known and safe low state. As a result, the input is prevented from floating, which could potentially lead to excessive current flow or susceptibility to electromagnetic interference. Some devices, such as certain types of sensors or switches, naturally provide a connection to ground when activated. Using a pull-down resistor complements such devices, ensuring compatibility and consistent behavior with other circuit elements. When a short circuit occurs between the input pin and ground, the pull-down resistor restricts the amount of current flowing through the shorted path. As a result, overheating of the circuit is prevented and the risk of damage to sensitive components (e.g., electrical fire) is reduced. In addition, pull down resistors help mitigate the risk of overload on the power supply or other connected devices by limiting the current flow in the event of a short circuit. This ensures safer operation and protects against potential hazards associated with excessive current draw. By limiting the current flow during a short circuit, pull-down resistors help minimize the extent of damage to the circuitry and improve the overall robustness of the system. This can extend the operational lifespan of the equipment and reduce maintenance costs. The presence of pull-down resistors enhances the reliability of the circuit by reducing the likelihood of catastrophic failures due to short circuits. This is particularly important in safety-critical applications where uninterrupted operation is essential.

In electronic logic circuits, a pull-up resistor (PU) or pull-down resistor (PD) is a resistor used to ensure a known state for a signal. It is typically used in combination with components such as switches and transistors, which physically interrupt the connection of subsequent components to ground or to VCC. Closing the switch creates a direct connection to ground or VCC, but when the switch is open, the rest of the circuit would be left floating (i.e., it would have an indeterminate voltage).

For a switch that is used to connect a circuit to VCC (e.g., if the switch or button is used to transmit a “high” signal), a pull-down resistor connected between the circuit and ground ensures a well-defined ground voltage (i.e. logical low) across the remainder of the circuit when the switch is open. For a switch that is used to connect a circuit to ground, a pull-up resistor (connected between the circuit and VCC) ensures a well-defined voltage (i.e. VCC, or logical high) when the switch is open.

Upon detection of a HIGH signal, controller 16 generates an output signal. The circuit is electrically isolated via 4N35 4-pin single channel optoisolator 17.

The diagram depicts five common relays 18 used in the automotive industry. Each relay is controlled by the optoisolator. An optoisolator (also known as an optical coupler, photocoupler, optocoupler) is a semiconductor device that transfers an electrical signal between isolated circuits using light. The basic working principle of an optoisolator involves the conversion of an electrical signal into light, transmission of that light across an isolation barrier, and then reconversion back into an electrical signal. The process is accomplished through the emitter (an LED) and the receiver (usually a phototransistor). The emitter is essentially an LED. When an electric current passes through the emittor, it emits light. The intensity of the emitted light is proportional to the electrical signal. The receiver (often a phototransistor) is sensitive to light. When the emitted light from the

LED strikes the phototransistor, it generates an electric current. In this way, the original electrical signal is regenerated. One significant advantage is that there is no electrical connection between the input and output (e.g., they are isolated). As a result, high voltages are prevented from one side affecting the other and can be a crucial safety feature.

RY6 activates a defined controller marked U9. This defined controller is used for digital communication with the host device via any established protocol in either a wired, or wireless configuration. This controller can be used to initiate communication with the host device, any display medium, or display used to alert the user.

Device 5 can connect to a host using a communications module that includes any suitable method or protocol, such as OBD-II, Bluetooth®, Wi-Fi, Z-Wave, and the like. The connectivity overrides controls to the environment (e.g., vehicle) and alerts the end user. For example, the device in an automotive configuration can supersede commands to the primary/auxiliary fuel delivery pump, control circuit, entry/exit egress controls, interior, exterior, and/or any illumination method used to alert the end user. The communications module can therefore include any device for transmission (e.g., analog, digital, wireless, etc.) and/or reception of signals for communication purposes.

For example, a wireless communications module may use signals formatted for communication with one or more wireless networks according to one or more of a number of communication systems including but are not limited to wireless networks such as cellular or satellite phone networks, 2G, 3G, 4G, GSM, CDMA, WCDMA networks, Municipal Wi-Fi, GPRS, iBurst, WiBro/WiMAX, UMTS-TDD, HSPA, EVDO, LTE, wireless local area networks, WiFi®, WiMAX®, personal area networks, Bluetooth®, Wireless USB, ZigBee®, Digital Enhanced Cordless Telecommunications (DECT), and/or other current or future wireless communication systems. A wireless terminal may be configured in one or more of various forms of handheld/mobile and/or stationary communication, control and/or computing devices.

Temperature monitoring can be employed using any suitable method. In some embodiments, the temperature of the environment can be determined using any temperature monitoring device to determine ambient temperature. A maximum and minimum threshold can be set such that once the threshold has been exceeded, appropriate climate controls are enabled. For example, if an occupant is detected and the temperature within the interior of a vehicle exceeds a threshold range (e.g., below 50 degrees or above 80 degrees), the corresponding heating or cooling functions will automatically be enabled. The threshold temperature range can therefore have a minimum or maximum or at least (or no more than) about 50, 55, 60, 65, 70, 75, or 80 degrees.

In some embodiments, device 5 can be configured to unlock one or more doors in an environment once the threshold has been exceeded. In this way, egress into the environment can be achieved to reduce the likelihood of an emergency and to abate the triggering event (e.g., reduce the temperature within the environment, remove the occupant from the environment). One or more additional functions can also be enabled, such as operation of the interior lights of the vehicle, audible alerts (such as chimes, buzzes), vocally recorded messages, screen readable messages, screen displayed images, warning labels and messages, operation of the audio system, and prevention of removal of the ignition key. Other alert signals such as tactile signals and vibration emitting signals can also be used.

Signals for the exterior of the vehicle may include the horn, the exterior lights, the vehicle's burglar alarm siren, and signals received by remote communication systems.

When a triggering event occurs, device 5 can be configured to alert an end user of the triggering event. The end user can be the vehicle owner, an assigned individual and/or a parent in some embodiments. Specifically, the device can communicate a message and/or symbols to the end user via text message to the end user's phone, a phone call to the number associated with the end user, playing an auditory sound or tone on the end user's phone or other device, call emergency services (the police, 911, the fire department, etc.), or combinations of these. These can be included in the corrective action of the system.

This defined controller is used for digital communication with the host device via any established protocol in either a wired, or wireless configuration. This controller can be used to initiate communication with the host device, any lighting controller, or lights used to alert the user.

The presently disclosed subject matter offers many advantages over prior art systems and devices. Specifically, the disclosed system includes a zoned structure that enables precise localization of issues within a complex system, enhancing accuracy and efficiency in problem resolution. By segmenting the system into distinct zones, any arising issue can be swiftly identified and addressed without the need for extensive scanning of the entire systems (many cars, or rows in a bus). Such a targeted approach to issue localization can save valuable time by pinpointing the exact origin of an emergency.

Further, zoning capabilities contribute to the scalability and flexibility of system 5.

In addition, by combining multiple sensors, the system achieves significantly greater accuracy in occupancy detection. For example, the use of the LIDAR sensor for precise distance measurements significantly reduces false positives, enhancing overall reliability.

Moreover, by considering vehicle status through voltage monitoring, the system can adapt its functionality based on whether the vehicle is running, accessory mode, or off, improving resource allocation and system efficiency reducing the likelihood of receiving false alarms, separately of the offsets and adjustments.

Furthermore, the real-time data fusion and analysis enable the system to make informed decisions and trigger appropriate responses promptly.

By integrating diverse sensor data, the system provides comprehensive insights into the monitored environment, facilitating proactive measures to ensure occupant comfort, safety, and security.

The multi-sensor confirmation mechanism significantly reduces false positives and enhances the system's accuracy in detecting true occupancy within the monitored zone.

Advantageously, focusing the field of view of sensor 10 vertically reduces the likelihood of false alarms triggered by movement outside the designated column zone.

Overall, this approach to sensor integration and logic flow enhances the system's efficiency and effectiveness, making it a robust solution for monitoring a zone.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A detection and monitoring system, the system comprising:
a first sensor configured to detect a presence or absence of a human or animal occupant within a zone of an environment;
a second sensor configured to operate concurrently with the first sensor, wherein detection requires fusion of outputs from both sensors using AND-gate logic such that the presence of a human or animal occupant within the zone is confirmed only when both sensors agree, thereby distinguishing the human or animal occupant from an inanimate object;
a communications module that initiates communication with an end user when a triggering event occurs while the fused outputs confirm the presence of the human or animal occupant within the zone during detection of the human or animal occupant within the zone of the environment.

2. The system of claim 1, wherein the first sensor is a passive infrared sensor and the second sensor is a Light Detection and Ranging (LIDAR) sensor, each operating concurrently and providing fused outputs under AND-gate logic.

3. The system of claim 1, wherein the environment is the interior of a vehicle.

4. The system of claim 1, wherein the triggering event is a temperature within the zone greater or less than a threshold temperature range.

5. The system of claim 1, wherein the occupant is a child.

6. The system of claim 1, further comprising a pressure sensor, momentary switch, or both.

7. The system of claim 1, further comprising a timer.

8. The system of claim 1, wherein the field of view of at least one sensor is about 110 degrees wide and about 22 degrees tall.

9. The system of claim 1, wherein at least one sensor is rotatable between a first position and a second position that differ by about 90 degrees to enable columnar detection of the occupant within the zone.

10. The system of claim 1, further comprising a temperature and humidity sensor.

11. A method of detecting and monitoring an occupant within a zone of an environment, the method comprising:
concurrently operating the first sensor and the second sensor of the system of claim 1 to detect the presence or absence of the human or animal occupant within the zone;
confirming the presence of the human or animal occupant only when both the first and second sensors detect the presence of the human or animal occupant within the zone and agree under AND-gate logic with fused outputs, thereby distinguishing the human or animal occupant from the inanimate object;
monitoring the human or animal occupant at predetermined time intervals by confirming the presence of the human or animal occupant within the zone using concurrent detection and data fusion of the first and second sensors;
ceasing the detecting and monitoring when the human or animal occupant is no longer confirmed by at least one of the first and second sensors;
wherein the method is performed by a system powered primarily by an external electrical source to transmit an emergency communication.

12. The method of claim 11, wherein the predetermined time interval is about 0.1-5 minutes.

13. The method of claim 11, wherein voltage of the system is monitored and corrected to reduce error.

14. The method of claim 11, wherein temperature and humidity within the zone is further monitored.

15. The method of claim 11, wherein the corrective action is contacting an end user, contacting emergency services, activating a feature of the environment, or combinations thereof.

16. The method of claim 15, wherein activating a feature of the environment is selected from rolling down a window, turning on an air conditioning feature, rolling up a window, unlocking at least one door, sounding an alarm, or combinations thereof.

17. The method of claim 11, wherein the first sensor is a passive infrared sensor, and the second sensor is a Light Detection and Ranging (LIDAR) sensor.

18. The method of claim 11, wherein the environment is the interior of a vehicle.

19. The method of claim 11, wherein the triggering event is a temperature within the zone greater or less than a threshold temperature range.

20. The method of claim 11, wherein the occupant is a child.
